(19) United States
(12) Patent Application Publication
(10) Pub. No.: US 2008/0159094 A1
(43) Pub. Date: Jul. 3, 2008

(54) DISC DRIVE AND METHOD FOR DETERMINING WRITE PARAMETERS

(75) Inventor: CHENG-HUI LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,111

(22) Filed: Dec. 28, 2006

(51) Int. Cl. G11B 7/00

(52) U.S. Cl. 369/44.32

(57) ABSTRACT

A method for controlling write parameters in a data-write process includes steps of: emitting a laser beam to be focused on a disc to write data onto the disc; determining whether a check-point predetermined for the disc is detected; at occurrence of the check-point is detected, pausing the data-write process and starting to detect a quality of the data; judging whether a block error rate of the data exceeds a predetermined rate; calculating a write speed based on the block error rate; and adjusting the write parameters based on the quality and the write speed.

### BACKGROUND OF THE INVENTION

1. Field of the Invention

This invention relates to disc drives and methods for determining write parameters thereof.

2. Description of Related Art

Recordable discs such as DVD-R/RWs, DVD+R/RWs, and CD-R/RWs are popular storage media in consumer electronics markets. Related disc drives for writing data onto the recordable discs are also widely used.

A typical disc drive emits a laser beam onto a disc to write data. Write parameters that affect a written quality of the disc include laser power, tilt angle, and focus depth of the laser beam. For example, the laser power of the laser beam affects optical reflectances of a recording layer of the disc. If the laser power of the laser beam is not at an appropriate level, data written onto the disc by the laser beam may be not readable.

Generally, an optimal power calibration (OPC) process is implemented to determine an optimal laser power for the disc drive to write the disc. The optimal laser power is determined by performing a series of writing tests in a power calibration area (PCA) of the disc. During the writing tests, some laser powers are employed to write test data onto the PCA, and the written quality of the test data is analyzed to derive the optimal laser power from the laser powers. The OPC process is usually done before writing user data onto the disc.

However, during a write process, the optimal laser power may not be an appropriate power to write user data onto the disc because some sections of the disc may have fingerprints or dust. Moreover, the written quality may also be affected by an obliquity of a recording layer of the disc, the tilt angle of the laser beam is prone to be adjusted to adapt to the obliquity of the recording layer during the write process.

Therefore, a method and an apparatus for controlling the write parameters during the write process are desired.

### SUMMARY OF THE INVENTION

A method for controlling write parameters in a data-write process includes steps of: emitting a laser beam to be focused on a disc to write data onto the disc; determining whether a check-point predetermined for the disc is detected; at occurrence of the check-point is detected, pausing the data-write process and starting to detect a quality of the data; judging whether a block error rate of the data exceeds a predetermined rate; calculating a write speed based on the block error rate; and adjusting the write parameters based on the quality and the write speed.

A method for writing data to a disc includes steps of: writing the disc with a write speed; emitting a laser beam having a plurality of optical parameters to the disc and receiving the laser beam reflected from the disc; generating servo error signals and data signals according to the received laser beam; detecting the servo error signals; at occurrence of an error is detected from the servo error signals, pausing writing and executing an off-line data test for detecting the data signals; adjusting the write speed of the disc and the optical parameters of the laser beam according to a detect result of the off-line data test; continuing writing the disc with the adjusted write speed and emitting the laser beam with the adjusted optical parameters.

A disc drive includes an optical pickup unit, a signal processing unit, an on-line monitor module, an off-line monitor module, and a control module. The optical pickup unit is used for emitting a laser beam to be focused on a disc to write data onto the disc, detecting a reflected laser beam from the disc, and generating electronic signals based on the reflected laser beam. The signal processing unit is used for processing the electronic signals and controlling a laser power of the laser beam. The on-line monitor module is used for detecting whether anyone of a group comprising of an error and a check-point is detected based on the processed electronic signals. The off-line monitor module is coupled to the on-line monitor module for detecting a quality of the data based on the processed electronic signals at occurrence of anyone of the group comprising of the error and the check-point. The control module is constructed and arranged for adjusting write parameters of the disc drive based on the quality detected by the off-line monitor module.

Other advantages and novel features will become more apparent from the following detailed description of preferred embodiments when taken in conjunction with the accompanying drawings, in which:

### BRIEF DESCRIPTION OF THE DRAWINGS

Many aspects of the disc drive and write parameters controlling method thereof can be better understood with reference to the following drawings. The components in the drawings are not necessarily to scale, the emphasis instead being placed upon clearly illustrating the principles of the present system and method for controlling write parameters. Moreover, in the drawings, like reference numerals designate corresponding parts throughout the several views.

FIG. 1 is a block diagram of a disc drive in accordance with an exemplary embodiment, the disc drive including an optical pickup unit;

FIG. 2 is a more detailed block diagram of the disc drive of FIG. 1;

FIG. 3 is a schematic diagram illustrating an optical system of the optical pickup unit of FIG. 1;

FIG. 4 is a flow chart illustrating a controlling procedure of write parameters controlling method;

FIG. 5 is a graph illustrating β values employing a traditional write parameters controlling method;

FIG. 6 is a graph illustrating β values employing the write parameters controlling method of FIG. 4;

FIG. 7 is a graph illustrating parity inner errors employing the traditional write parameters controlling method;

FIG. 8 is a graph illustrating parity inner errors employing the write parameters controlling method of FIG. 4;

FIG. 9 is a graph illustrating jitter values employing the traditional write parameters controlling method; and

FIG. 10 is a graph illustrating jitter values employing the write parameters controlling method of FIG. 4.

### DETAILED DESCRIPTION OF THE INVENTION

Reference will now be made to the drawings to describe the preferred embodiment of the present system and method for controlling write parameters, in detail.

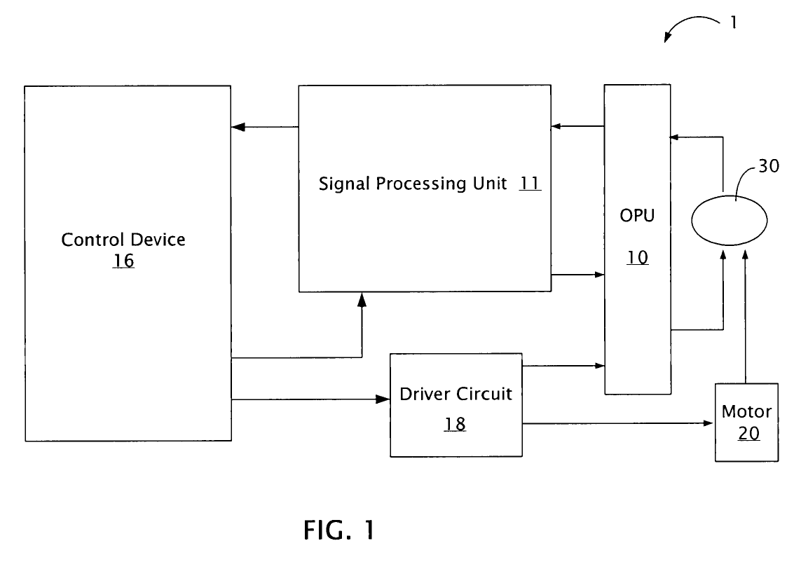

Referring to FIG. 1, a disc drive 1 is used for writing data onto a disc 30. The disc drive 1 includes an optical pickup unit (OPU) 10, a motor 20 for rotating the disc 30, and a driver circuit 18. The OPU 10 is used for emitting a laser beam onto the disc 30 and detects a reflected laser beam from the disc 30. The OPU 10 further analyzes the reflected laser beam and generates electronic signals containing information about a quality of written data.

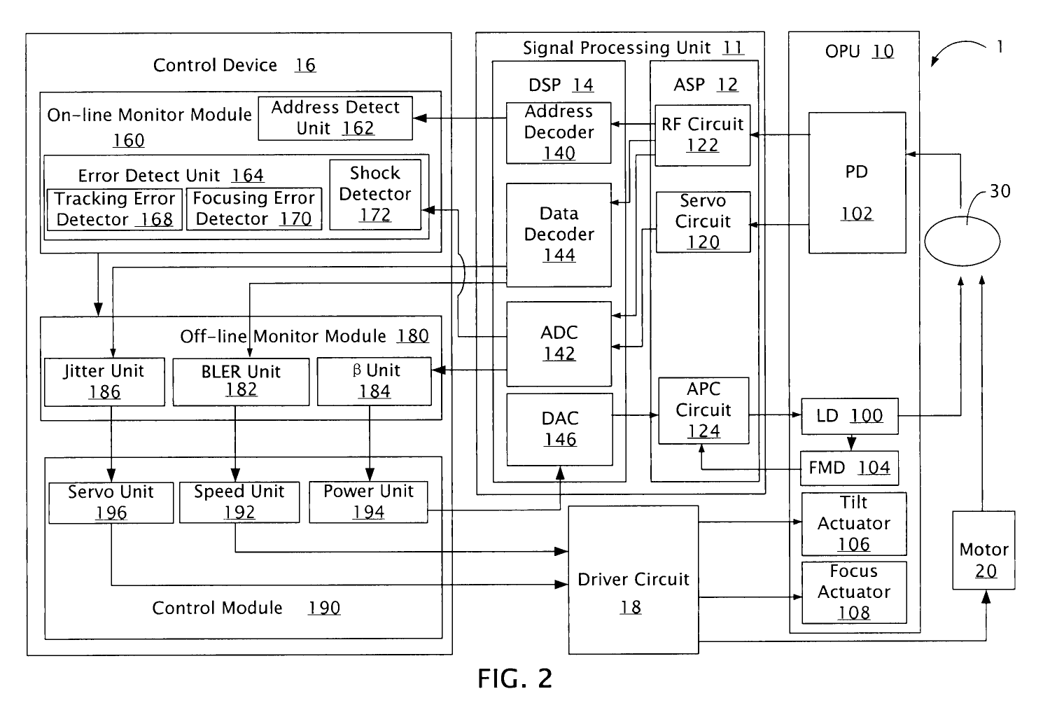

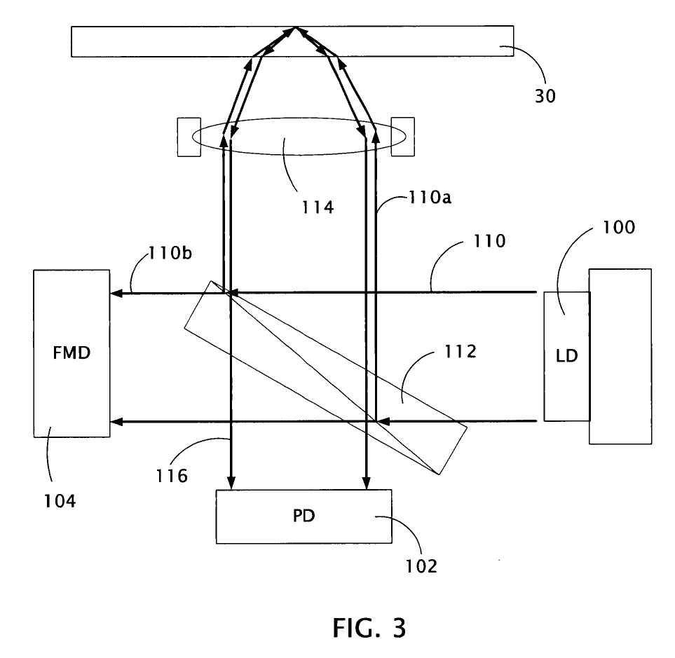

Referring to FIG. 2, a more detailed block diagram of the disc drive 1 is illustrated. The OPU 10 includes a laser diode (LD) 100, a photo diode (PD) 102, a front monitor diode (FMD) 104, a tilt actuator 106, and a focus actuator 108. Referring also to FIG. 3, a schematic diagram showing a laser beam transmission path of the OPU 10 is illustrated. The LD 100 emits and projects the laser beam (hereinafter referred as to emitted laser beam 110) onto an optical splitter 112. The optical splitter 112 then splits the emitted laser beam into two, i.e., a reflected laser beam 110a and a transmitted laser beam 110b. The reflected laser beam 110a is then focused onto the disc 30 via an optical lens 114. The disc 30 receives the reflected laser beam 110a and projects a disc reflected laser beam 116 back to the optical lens 114. The disc reflected laser beam 116 is then received by the PD 102 via the optical lens 114 and the optical splitter 112. The PD 102 analyzes the disc reflected laser beam 116 and generates electronic signals according to the disc reflected laser beam 116.

The FMD 104 receives the transmitted laser beam 110b and generates FMD signals indicating optical parameters, such as an laser power of the emitted laser beam 110. The tilt actuator 106 and the focus actuator 108 are used for positioning the optical lens 114 so as to adjust a projecting position of the reflected laser beam 110a corresponding to the disc 30.

The disc drive 1 further includes a signal processing unit 11 configured for processing the electronic signals and for controlling the laser power. A control device 16 is stored in the disc drive 1 for controlling the signal processing unit 11 and the driver circuit 18 to adjust the projecting position of the reflected laser beam 110a and the rotational speed of the motor 20 based on the electronic signals processed by the signal processing unit 11, thus optimizing write parameters of the disc drive 1.

The signal processing unit 11 includes an analog signal processor (ASP) 12 coupled to the OPU 10, and a digital signal processor (DSP) 14 coupled to the ASP 12 and connected to the control device 16. The ASP 12 includes a servo circuit 120, a radio-frequency (RF) circuit 122, and an automatic power control (APC) circuit 124. The servo circuit 120 and the RF circuit 122 are capable of processing the electronic signals from the OPU 10 for respectively generating a servo signal and a RF signal (also known as a high frequency signal, HF signal). The servo signal and the RF signal are transmitted to the DSP 14.

The APC circuit 124 is configured for receiving the FMD signals and adjusting an electrical power of the LD 100, thus adjusting the laser power of the emitted laser beam 110 according to the FMD signals by changing the electrical power of the LD 100.

The DSP 14 includes an address decoder 140, a data decoder 144, an analog-to-digital converter (ADC) 142, and a digital-to-analog converter (DAC) 146. The address decoder 140 is used for receiving and decoding the RF signal transmitted from the RF circuit 122 and for generating an address signal. The data decoder 144 is used for receiving and decoding the RF signal and for generating a data signal. The address signal and the data signal are then transmitted to the control device 16. The ADC 142 is capable of converting the RF signal and the servo signal into a first digital signal and a second digital signal respectively, and for further transmitting the first digital signal and the second digital signal to the control device 16. The control device 16 controls the APC circuit 124 to adjust the value of the electrical power of the LD 100 via the DAC 146.

The control device 16 is configured for monitoring the write process and optimizing the write parameters in real-time. The control device 16 includes an on-line monitor module 160, an off-line monitor module 180, and a control module 190.

The on-line monitor module 160 is configured for monitoring the write process without interrupting the write process. The on-line monitor module 160 includes an address detect unit 162 and an error detect unit 164. The address detect unit 162 is connected to the address decoder 140 so that the address signal is inputted into the address detect unit 162. According to the address signal, the address detect unit 162 detects check-points that are predetermined by the disc drive 1 for the disc 30 to divide the disc 30 into a plurality of sections. If one of the sections has been written, that is, a check-point is detected, the on-line monitor module 160 signals the off-line monitor module 180 to perform an off-line data test process. During the off-line data test process, the disc drive 1 pauses the write process and detects the quality of the written data.

The error detect unit 164 is electrically coupled to the ADC 142 for detecting errors during the write process according to the first digital signal received from the ADC 142. If any errors are detected, the on-line monitor module 160 will signal the off-line monitor module 180 to perform the off-line data test process. The error detect unit 164 includes a tracking error detector 168, a focusing error detector 170, and a shock detector 172.

The tracking error detector 168 is capable of detecting any track errors by monitoring a value of a tracking error signal extracted from the first digital signal. In other words, if the value of the tracking error signal exceeds a first predetermined value, the track errors occurred during the write process.

Similarly, the focusing error detector 170 and the shock detector 172 are capable of detecting focus errors and any shock errors respectively by monitoring values of a focusing error signal and a shock signal. The focusing error signal and the shock signal are extracted from the first digital signal. That is, if the focusing error signal exceeds a second predetermined value or the shock signal exceed a third predetermined value, the focus error or the shock error occurred during the write process respectively. If at least one of the track error, the focus error, and the shock error is detected, the error detect unit 164 transmits the track error, the focus error, or the shock error to the off-line monitor module 180 correspondingly, and signals the off-line monitor module 180 to perform the off-line data test.

The off-line monitor module 180 includes a block error rate (BLER) unit 182, a β unit 184, and a jitter unit 186. The control module 190 includes a speed unit 192 corresponding to the BLER unit 182, a power unit 194 corresponding to the β unit 184, and a servo unit 196 corresponding to the jitter unit 186.

The BLER unit 182 is electrically coupled to the data decoder 144, and is used for detecting a block error rate based on the data signal from the data decoder 144. The block error rate represents a number of a parity inner error (PIE) and a parity outer error (POE) of the written data. Both of the PIE and the POE can be corrected in the disc drive 1, such as a DVD disc drive. However, if the BLER is very large, especially larger than a predetermined rate, a parity inner fail (PIF) or parity outer fail (POF) is prone to occur in the data written in the disc 30. Neither of the PIF and the POF can be corrected by the DVD disc drive, thus the quality of the written data may have been reduced. The detected BLER is sent to the speed unit 192 of the control module 190.

The speed unit 192 is coupled to the driver circuit 18 for adjusting a write speed of the disc drive 1 based on the BLER. The write speed is an amount of data written onto the disc 30 per second, and is usually measured by mega bytes per second (MB/s). For example, a signal DVD write speed (1×) is 1.32 MB/s. Generally, if the BLER exceeds the predetermined rate, the speed unit 192 sends a speed command to the driver circuit 18 for slowing down the write speed of the disc drive 1. The motor 20, which is connected to the driver circuit 18, changes the rotational speed of the disc 30 based on the speed command. The write speed is thus adjusted.

The β unit 184 is used for receiving the second digital signal generated by the ADC 142. The β unit 184 calculates a β value based on the second digital signal. The β value is an asymmetry parameter that characterizes an asymmetry of a waveform of the radio frequency (RF) signal for evaluating whether the laser power of the emitted laser beam 110 is at an optimal laser power. A typical β value calculating formula is β=(A1−A2)/(A1+A2), wherein the A1 is a high amplitude of the RF signal; the A2 is a low amplitude of the RF signal. Different optical discs have different optimal β values corresponding to the optimal laser power. The optimal β values are prewritten into the optical discs by optical discs manufacturers.

The β value is sent to the power unit 194 of the control module 190. The power unit 194 generates a power control signal according to the β value and then sends the power control signal to the DAC 146. The DAC 146 converts the power control signal into an analog signal and sends the analog signal to the APC circuit 124. The APC circuit 124 automatically controls the electrical power of the LD 100 based on the FMD signals generated by the FMD 104 and the analog signal. Generally, if the β value is greater than an optimal β value of the disc 30, the power control signal is configured to decrease the electrical power of the LD 100, if the β value is smaller than the optimal β value, the power control signal is configured to increase the electrical power of the LD 100.

The jitter unit 186 is used for detecting a jitter value of the data signal decoded by the data decoder 144. The jitter value is sent to the servo unit 196 for adjusting a state of the emitted laser beam 110 related to the disc 30. For example, if the jitter value exceeds a predetermined jitter value, the servo unit 196 sends a servo control signal to the driver circuit 18 to control the tilt actuator 106 and the focus actuator 108, thus adjusting a tilt angle of the optical lens 114 and focus depth of the emitted laser beam 110 on the disc 30 until the jitter value reaches a minimum value.

The disc drive 1 can detect the quality of the written data during the write process. The write parameters are adjusted based on detecting results of the off-line monitor module 180 so that the write parameters is adaptive to the disc 30, thus the quality of the written data in the disc 30 is improved.

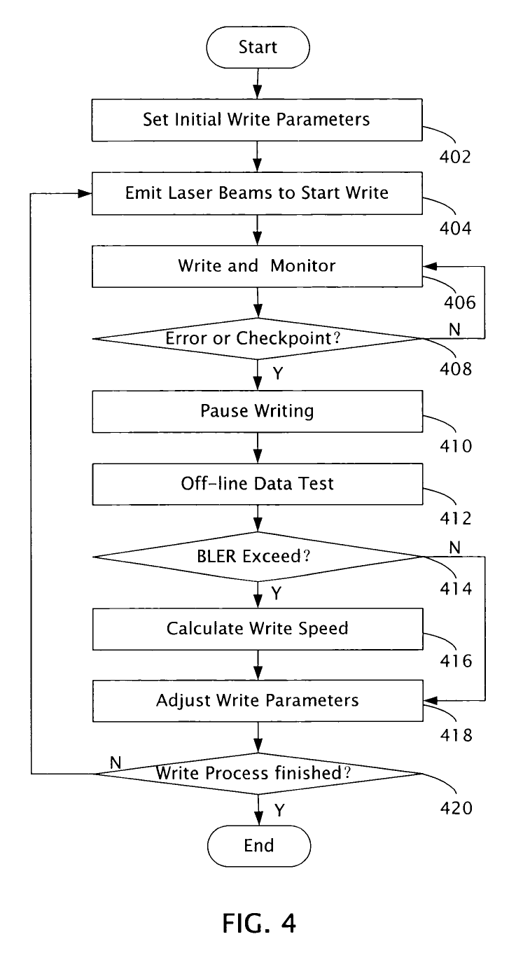

Referring to FIG. 4, a controlling procedure of a write parameters controlling method is illustrated.

In step 402, the disc drive 1 sets initial write parameters. The initial write parameters can be obtained in a plurality of manners. For example, the disc drive 1 identifies the disc 30 by reading a media ID (MID) embedded in the disc 30, thus optimized write parameters stored in the disc drive 1 according to the MID is selected. Furthermore, if there are no optimized write parameters stored in the disc drive 1 corresponding to the disc 30 as the disc 30 is a new type or manufactured by an unknown manufacturer, default write parameters also can be employed as the initial write parameters to write the disc 30.

In step 404, the disc drive 1 starts emit the laser beam to write the disc 30 with the initial write parameters.

In step 406, the disc drive 1 writes data onto the disc 30 and monitors the write process. The check-point, the tracking error signal, the focusing error signal, and the shock signal are monitored during the write process.

In step 408, at an occurrence of the check-point is detected during the write process, the disc drive 1 pauses writing (step 410) to start the off-line data test process (step 412). At the occurrence of anyone in a group of the tracking error signal, the focusing error signal, and the shock signal is detected to be exceeding their own predetermined values, the disc drive 1 pauses writing (step 410) to start the off-line data test process (step 412) as well.

In step 412, the disc drive 1 starts the off-line data test process to detect the quality of the written data written in step 406. The off-line data test process includes detecting of the β value, the block error rate, and the jitter value.

In step 414, the disc drive 1 determines whether the block error rate detected in step 412 exceeds the predetermined rate. If the block error rate exceeds the predetermined rate, that is, a deceleration of the write speed is required, the procedure proceeds to step 416. If the block error rate does not exceed the predetermined rate, the procedure proceeds directly to step 418.

In step 416, the disc drive 1 calculates the write speed based on the block error rate detected in step 412.

In step 418, the disc drive 1 adjusts the write parameters based on the adjusted write speed and the off-line data test results in step 412. For example, the tilt angle and the focus depth of the emitted laser beam 110 are adjusted based on the detected jitter value. If the detected β value is greater than the optimal β value, the electrical power of the LD 100 may be decreased; else the electrical power of the LD 100 may be increased.

In step 420, the disc drive 1 determines whether the write process has finished. If the data intended to be written onto the disc 30 has been written, the procedure is terminated. If the data have not been written completely, the procedure loops back to step 404 to continue writing with the adjusted write parameters in step 418.

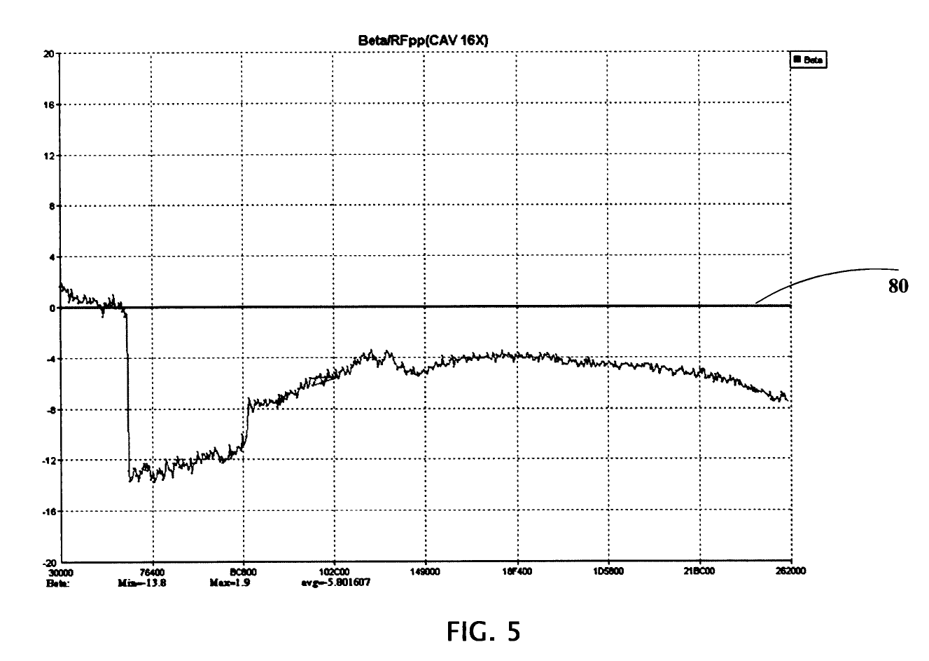

The write parameters controlling method can detect the quality of the written data in the write process. The write parameters are adjusted based on detecting results of the off-line data test so that the write parameters is adaptive to the disc 30, thus the quality of the written data is improved. An improvement of the quality of the written data is illustrated through FIG. 5 to FIG. 10.

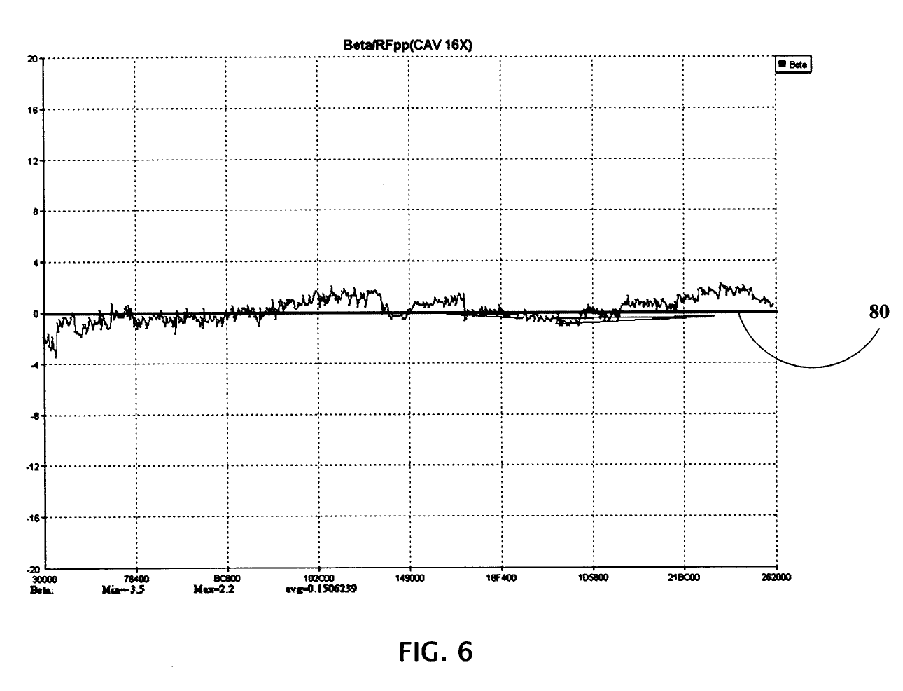

Referring to FIG. 5, values of the β variable when writing data on different physical sectors of the disc 30 at a relatively high write speed with a traditional write parameters controlling method are illustrated. Referring to FIG. 6, values of the β variable when writing data on different physical sectors of the disc 30 at the relatively high write speed with the disc drive 1 of FIG. 2 and the write parameters controlling method of FIG. 4 are illustrated. It is clear that the values of the β variable in FIG. 6 are closer to an optimal value 80 than the values in the FIG. 5. Generally, the more appropriate the laser power level is, the closer to the optimal value 80 of the β values. Therefore, the laser power levels obtained with the disc drive 1 of FIG. 2 and the write parameters controlling method of FIG. 4 are more proper than the laser power levels obtained with the traditional write parameters controlling method. That is, the disc drive 1 of FIG. 2 and the write parameters controlling method of FIG. 4 may improve accuracies of the laser power levels for writing data onto the disc 30.

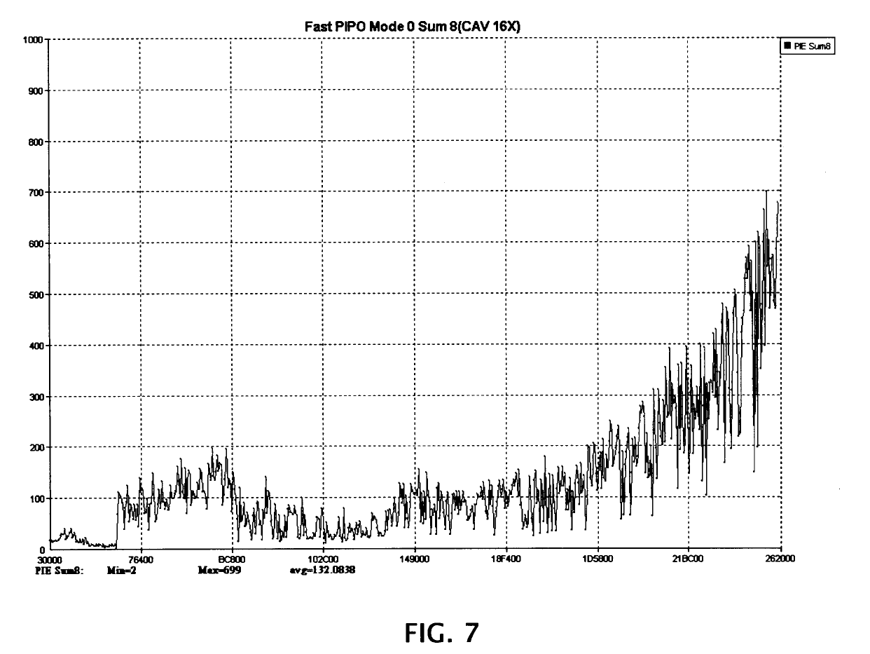

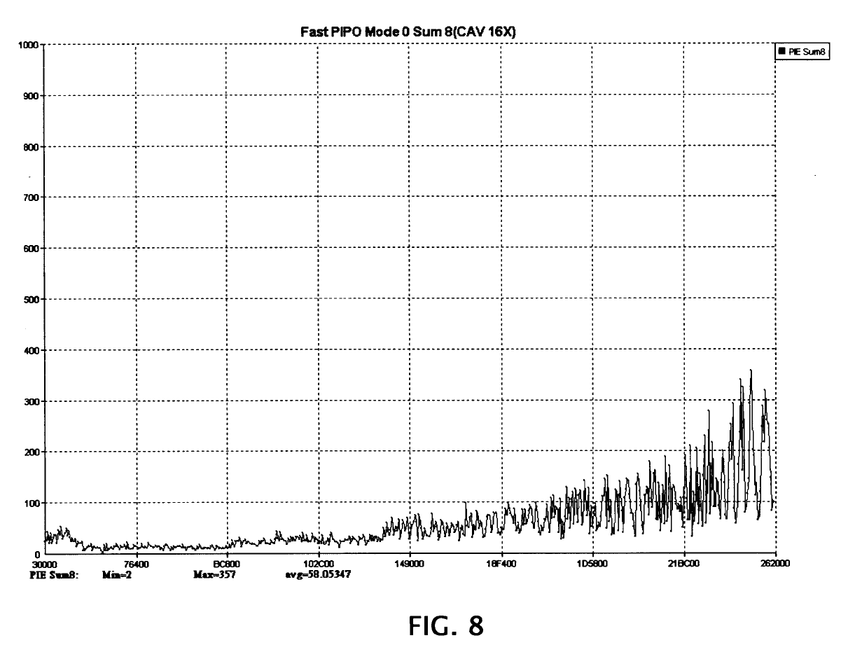

Referring to FIG. 7, values of a parity inner error (PIE) when writing data on different physical sectors of the disc 30 with the traditional write parameters controlling method are illustrated. Referring to FIG. 8, values of the PIE when writing data on different physical sectors of the disc 30 with the disc drive 1 of FIG. 2 and the write parameters controlling method of FIG. 4 are illustrated. It is clear that the values of the PIE in FIG. 8 are lesser than that of the PIE in FIG. 7. Therefore, the disc drive 1 of FIG. 2 and the write parameters controlling method of FIG. 4 may improve the quality of the written data.

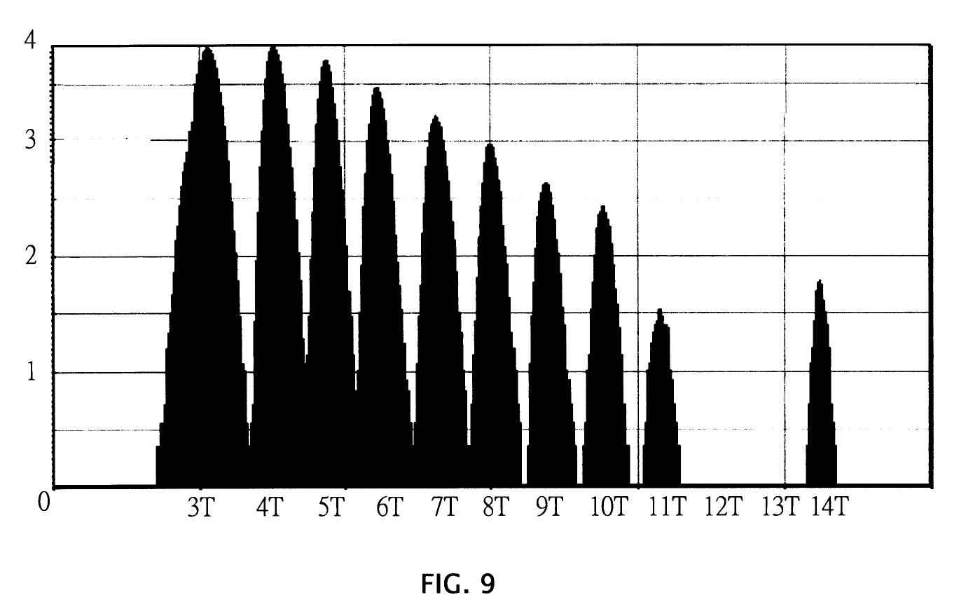

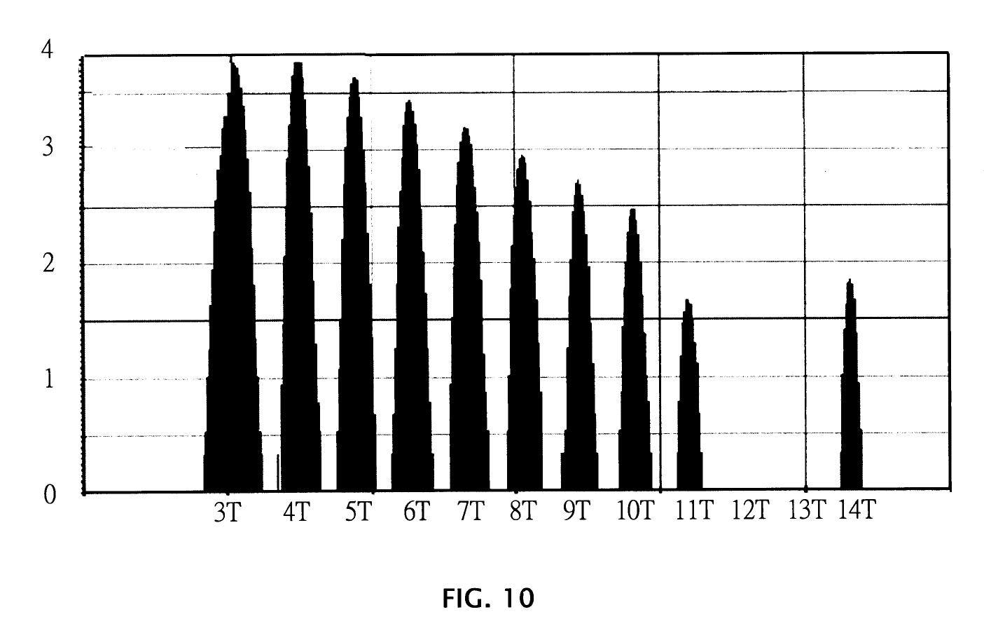

Referring to FIG. 9, values of a jitter when writing data on the disc 30 with the traditional write parameters controlling method are illustrated. Referring to FIG. 8, values of the jitter when writing data on the disc 30 with the disc drive 1 of FIG. 2 and the write parameters controlling method of FIG. 4 are illustrated. The abscissa represents pit lengths of the data written on the disc 30, and the ordinate represent frequencies of the pit lengths. Generally, jitter is employed to describe a frequency distribution of the pit lengths, the more concentrative of the pit lengths, the better of the quality of the written data is. That is, the smaller of the jitter value, the better of the quality of the written data is. It is clear that the jitter in FIG. 10 is more concentrative than that of FIG. 9. Therefore, the data writing apparatus 1 of FIG. 2 and the write parameters controlling method of FIG. 4 may improve the quality of the written data.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A method for controlling write parameters in a data-write process, the method comprising steps of:
emitting a laser beam to be focused on a disc to write data onto the disc;
determining whether a check-point predetermined for the disc is detected;
at occurrence of the check-point is detected, pausing the data-write process and starting to detect a quality of the data;
judging whether a block error rate of the data exceeds a predetermined rate;
calculating a write speed based on the block error rate; and
adjusting the write parameters based on the quality and the write speed.

2. The method as claimed in claim 1, wherein the write speed is decreased if the block error rate exceeds the predetermined rate.

3. The method as claimed in claim 1, wherein the step of determining whether the check-point predetermined for the disc is detected comprising the steps of:
generating an address signal according to the laser beam reflected from the disc, the address signal indicating an address of the disc being written; and
determining whether the check-point is detected based on the address of the disc.

4. The method as claimed in claim 1, wherein the step of detecting the quality of the data comprises steps of:
detecting a β value;
decreasing a laser power of the laser beam at occurrence of the β value is greater than an optimal β value that is prerecorded in the disc; and
increasing the laser power of the laser beam at occurrence of the β value is smaller than the optimal β value.

5. The method as claimed in claim 1, wherein the step of detecting the quality of the data comprises steps of:
detecting a jitter value; and
adjusting a tilt angle and a focusing depth of the laser beam if the jitter value exceeds a predetermined jitter value.

6. The method as claimed in claim 1, further comprising the step of: setting initial write parameters to write the data onto the disc.

7. The method as claimed in claim 1, further comprising the step of: continuing the data-write process with the adjusted write parameters.

8. A method for writing data to a disc, comprising steps of:
writing the disc with a write speed;
emitting a laser beam having a plurality of optical parameters to the disc and receiving the laser beam reflected from the disc;
generating servo error signals and data signals according to the received laser beam;
detecting the servo error signals;
at occurrence of an error is detected from the servo error signals, pausing writing and executing an off-line data test for detecting the data signals;
adjusting the write speed of the disc and the optical parameters of the laser beam according to a detect result of the off-line data test;
continuing writing the disc with the adjusted write speed and emitting the laser beam with the adjusted optical parameters.

9. The method as claimed in claim 8, wherein the error is selected from a group comprising of a tracking error signal, a focusing error signal, and a shock signal exceeding corresponding predetermined values.

10. The method as claimed in claim 8, wherein the optical parameters of the laser beam are selected from a group comprising of an laser power, a tilt angle relative to the disc, and a focus depth on the disc.

11. A disc drive, comprising:
an optical pickup unit for emitting a laser beam to be focused on a disc to write data onto the disc, detecting a reflected laser beam from the disc, and generating electronic signals based on the reflected laser beam;
a signal processing unit for processing the electronic signals and controlling a laser power of the laser beam;
an on-line monitor module for detecting whether anyone of a group comprising of an error and a check-point is detected based on the processed electronic signals;
an off-line monitor module coupled to the on-line monitor module for detecting a quality of the data based on the processed electronic signals at occurrence of anyone of the group comprising of the error and the check-point; and
a control module constructed and arranged for adjusting write parameters of the disc drive based on the quality detected by the off-line monitor module.

12. The disc drive as claimed in claim 11, wherein the processed electronic signals comprise an address signal, the on-line monitor module comprises an address detect unit for detecting the address signal to determine whether the check-point is detected, at occurrence of the check-point, the disc drive pauses writing to signal the off-line monitor module to detect the quality.

13. The disc drive as claimed in claim 11, wherein the processed electronic signals comprise a first digital signal, the on-line monitor module comprises an error detect unit for detecting the error based on the first digital signal, at occurrence of the error, the disc drive pauses writing to signal the off-line monitor module to detect the quality.

14. The disc drive as claimed in claim 13, wherein the error detect unit comprises a tracking error detector for detecting a tracking error signal and generating the error if the tracking error signal exceeds a first predetermined value.

15. The disc drive as claimed in claim 13, wherein the error detect unit comprises a focusing error detector for detecting a focusing error signal and generating the error if the focusing error signal exceeds a second predetermined value.

16. The disc drive as claimed in claim 13, wherein the error detect unit comprises a shock detector for detecting a shock signal and generating the error if the shock signal exceeds a third predetermined value.

17. The disc drive as claimed in claim 1, wherein the off-line monitor module comprises a block error rate unit for detecting a block error rate of the data, the control module comprises a speed unit for adjusting write speed based on the block error rate.

18. The disc drive as claimed in claim 1, wherein the off-line monitor module comprises a β unit for detecting a β value, the control module comprises a power unit for adjusting the laser power of the laser beam via the signal processing unit based on the β value.

19. The disc drive as claimed in claim 1, wherein the off-line monitor module comprises a jitter unit for detecting a jitter value, the control module comprises a servo unit for adjusting a tilt angle and a focusing depth of the laser beam at occurrence of the jitter value exceeds a predetermined jitter value.

20. The disc drive as claimed in claim 19, wherein the optical pickup unit comprises a tilt actuator for adjusting the tilt angle of the laser beam and focus actuator for adjusting the focusing depth of the laser beam.
